(19) United States
(12) Patent Application Publication
(10) Pub. No.: US 2023/0005317 A1
(43) Pub. Date: Jan. 5, 2023

(54) SYSTEM AND METHOD FOR AUTHENTICATING A PERSON BASED ON MOTION DATA FOR ONE OR MORE EARPIECES WORN BY THE PERSON

(71) Applicant: Kyocera AVX Components Corporation, Fountain Inn, SC (US)

(72) Inventor: Laurent Desclos, San Diego, CA (US)

(21) Appl. No.: 17/853,234

(22) Filed: Jun. 29, 2022

Related U.S. Application Data
(60) Provisional application No. 63/216,604, filed on Jun. 30, 2021.

(51) Int. Cl. G07C 9/32; G06K 9/00; H04R 1/10

(52) U.S. Cl. CPC G07C 9/32; G06K 9/00536; H04R 1/1041

(57) ABSTRACT

A person authentication system is provided. The person authentication system includes one or more earpieces. The one or more earpieces can include one or more motion sensors. The person authentication system includes a computing system communicatively coupled to the one or more earpieces. The computing system is configured to obtain motion data indicative of motion of the one or more earpieces when the one or more earpieces are being worn by the person. The computing system is configured to determine a motion signature for the person based, at least in part, on the motion data. The motion signature can be unique to the person. The computing system can be even further configured to authenticate an identity of the person based, at least in part, on the motion signature.

### PRIORITY CLAIM

This application claims the benefit of priority of U.S. Provisional Patent Application Ser. No. 63/216,604, filed on Jun. 30, 2021, titled “System and Method for Authenticating a Person Based on Motion Data for One or more Earpieces Worn by the Person,” which is incorporated herein by reference.

### FIELD

The present disclosure relates generally to earpieces and, more particularly, to a system and method for authenticating a person wearing one or more earpieces based, at least in part, on motion data indicative of motion of the one or more earpieces.

### BACKGROUND

Earpieces are wearable devices that can be inserted into an ear of a person. Earpieces can include one or more electronic components (e.g., transducers) associated with converting an electrical signal into an audio signal. For example, the audio signal can be associated with an incoming call to a mobile computing device (e.g., smartphone, tablet) associated with the person. In this manner, the person can listen to the audio signal in private.

### SUMMARY

Aspects and advantages of embodiments of the present disclosure will be set forth in part in the following description, or may be learned from the description, or may be learned through practice of the embodiments.

In one aspect, a method of authenticating an identity of a person wearing one or more earpieces is provided. The method includes obtaining motion data indicative of motion of one or more earpieces worn by the person. The method includes determining a motion signature of the person based, at least in part, on the motion data. The motion signature can be unique to the person. The method includes authenticating the identity of the person based, at least in part, on the motion signature.

In another aspect, a person authentication system is provided. The person authentication system includes one or more earpieces. The one or more earpieces can include one or more motion sensors. The person authentication system includes a computing system communicatively coupled to the one or more earpieces. The computing system is configured to obtain motion data indicative of motion of the one or more earpieces when the one or more earpieces are being worn by the person. The computing system is configured to determine a motion signature for the person based, at least in part, on the motion data. The motion signature can be unique to the person. The computing system can be even further configured to authenticate an identity of the person based, at least in part, on the motion signature.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of a person authentication system.

FIG. 2 depicts a block diagram of components of an earpiece according to example embodiments of the present disclosure.

FIG. 3 depicts a flow diagram of a method for authenticating identity of a person wearing one or more earpieces according to example embodiments of the present disclosure.

FIG. 4 depicts a flow diagram of a method of determining a motion signature for a person according to example embodiments of the present disclosure.

FIG. 5 depicts a flow diagram of a method of authenticating an identity of a person wearing one or more earpieces according to example embodiments of the present disclosure.

FIG. 6 depicts a flow diagram of a method of authenticating an identity of a person wearing one or more earpieces according to example embodiments of the present disclosure.

FIG. 7A depicts motion data indicative of motion of an earpiece according to example embodiments of the present disclosure.

FIG. 7B depicts motion data indicative of motion of an earpiece according to example embodiments of the present disclosure.

FIG. 7C depicts motion data indicative of motion of an earpiece according to example embodiments of the present disclosure.

FIG. 8 depicts a block diagram of components of a computing system according to example embodiments of the present disclosure.

FIG. 9 depicts a modal antenna according to example embodiments of the present disclosure.

FIG. 10 depicts a two-dimensional radiation pattern associated with a modal antenna according to example embodiments of the present disclosure.

FIG. 11 depicts a frequency plot of a modal antenna according to example embodiments of the present disclosure.

FIG. 12 depicts a method a flow diagram of a method for authenticating identity of a person wearing one or more earpieces according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to authentication systems. A person authentication system can include or more earpieces. For instance, in some implementations, the one or more earpieces can include a first earpiece configured to be worn in a right ear of a person and/or a second earpiece configured to be worn in a left ear of the person. In some implementations, the one or more earpieces can include over-the-ear earpieces. In alternative implementations, the one or more earpieces can include in-ear earpieces.

The one or more earpieces can include one or more motion sensors. The one or more motion sensors can be configured to obtain motion data indicative of motion of the one or more earpieces. For instance, in some implementations, the one or more motion sensors can include one or more accelerometers configured to obtain data indicative of acceleration of the one or more earpieces along one or more axes. Alternatively, or additionally, the one or more motion sensors can include one or more gyroscopes configured to obtain data indicative of angular velocity of the one or more earpieces. It should be understood that the one or more motion sensors can include any suitable sensor configured to obtain data indicative of motion (e.g., acceleration, velocity, etc.) of the one or more earpieces.

The person authentication system can include a computing system. The computing system can be communicatively coupled to the one or more earpieces worn by the person. In some implementations, the computing system can be communicatively coupled to the one or more earpieces via one or more wireless networks. In this manner, the computing system can obtain motion data indicative of motion of the one or more earpieces being worn by the person. For instance, in some implementations, the computing system can obtain first motion data indicative of motion of a first earpiece worn in a first ear of the person. Additionally, the computing system can obtain second motion data indicative of motion of a second earpiece worn in a second ear of the person.

The computing system can be configured to determine a motion signature for the person based, at least in part, on the motion data indicative of motion of the one or more earpieces worn by the person. The motion signature can be indicative of a motion that is unique to the person. For instance, in some implementations, the motion signature can be indicative of a gait of the person. It should be understood that the motion signature can include any type of motion that is unique to the person. In some implementations, the computing system can include one or more machine-learned motion classifier models. In such implementations, the computing system can be configured to provide the motion data indicative of the motion of the one or more earpieces as an input to the one or more machine-learned motion classifier models. The one or more learned motion classifier models can be configured to classify the motion data to determine the motion signature for the person. Furthermore, in such implementations, the motion signature for the person can be provided as an output of the one or more machine-learned motion classifier models. The computing system can be configured to authenticate an identity of the person wearing the one or more earpieces based, at least in part, on the motion signature. For instance, in some implementations, the computing system can be configured to provide the motion signature as an input to one or more machine-learned motion classifier models. The one or more machine-learned motion classifier models can be configured to classify the motion signature to determine an identity of the person wearing the one or more earpieces. Furthermore, in such implementations, the identity of the person can be provided as an output of the one or more machine-learned motion classifier models.

The person authentication system according to example aspects of the present disclosure can provide numerous technical benefits and advantages. For instance, the computing system can determine a motion signature for a person wearing one or more earpieces based, at least in part, on motion data indicative of motion of the one or more earpieces. Furthermore, since the motion signature is unique to the person wearing the one or more earpieces, the computing system can authenticate the identity of the person wearing the one or more earpieces based, at least in part, on the motion signature. In this manner, person authentications systems according to example aspects of the present disclosure can more accurately authenticate the identity of persons wearing the one or more earpieces since authentication is based, at least in part, on motion (e.g., gait) that is unique to the person waring the one or more earpieces.

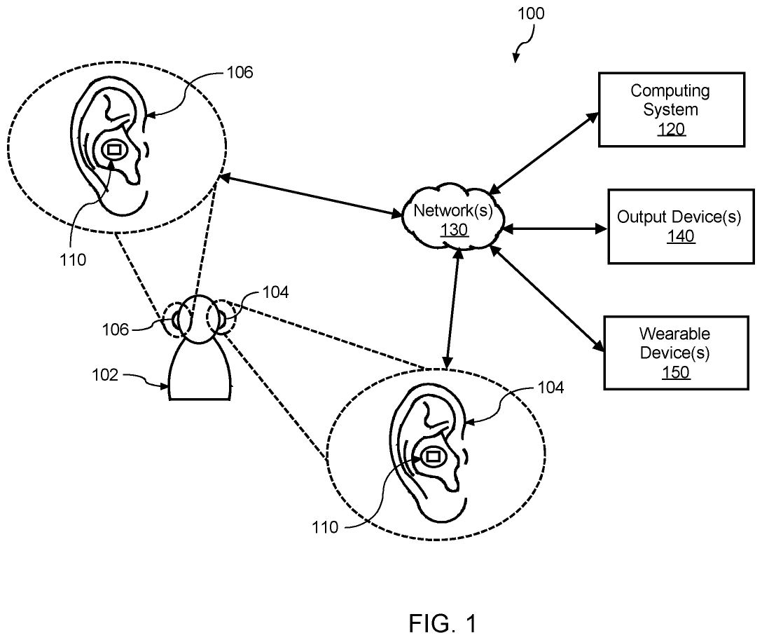

Referring now to the FIGS, FIG. 1 depicts a person authentication system 100 is provided. The person authentication system 100 can include one or more earpieces 110 configured to be worn by a person 102. For instance, in some implementations, the one or more earpieces can include a first earpiece and a second earpiece. The first earpiece can be configured to be worn in a first ear 104 (e.g., right ear) of the person 102. The second earpiece can be configured to be worn in a second ear 106 (e.g., left ear) of the person 102. In alternative implementations, the person authentication system 100 can include fewer earpieces (e.g., only one earpiece). It should be understood that the one or more earpieces 110 can include any suitable earpiece. For instance, in some implementations, the one or more earpieces 110 can include an over-the-ear earpiece. In alternative implementations, the one or more earpieces 110 can include an in-ear earpiece.

The person authentication system 100 can include a computing system 120. The computing system 120 can be communicatively coupled to the one or more earpieces 110. For instance, in some implementations, the computing system 120 can be communicatively coupled to the one or more earpieces 110 via one or more wireless networks 130. In some implementations, the one or more wireless networks 130 can include a cellular network. Alternatively, or additionally, the one or more wireless networks 130 can include a wireless local area network (WLAN), such as a 802.11 network (e.g., WiFi network). It should also be understood that the one or more wireless networks 130 can have any suitable topology. For instance, in some implementations, the one or more wireless networks 130 can be a mesh network. In such implementations, the one or more earpieces 110 (e.g., first earpiece and second earpiece) can communicate with one another via the mesh network. Alternatively, or additionally, the one or more earpieces 110 worn by the person 102 can communicate with one or more earpieces 110 worn by a different person via the mesh network.

The computing system 120 can be configured to obtain motion data indicative of motion of the one or more earpieces 110 being worn by the person 102. In some implementations, the motion data can include one or more signals transmitted from the one or more earpieces 110. For instance, in some implementations, the first earpiece worn in the first ear 104 of the person 102 can transmit one or more signals indicative of motion of the first earpiece. Additionally, the second earpiece worn in the second ear 106 of the person 102 can transmit one or more signals indicative of motion of the second earpiece.

In some implementations, the one or more earpieces 110 can be communicatively coupled to one or more motion sensor systems (e.g., wristband, smartwatch, etc.) worn by the person 102. For instance, the one or more earpieces 110 can be communicatively coupled to the one or more motion sensor systems via the one or more wireless networks 130. In this manner, the one or more earpieces 110 can obtain motion data from the one or more motion sensor systems. In some implementations, the one or more earpieces 110 can communicate the motion data obtained from the one or more motion sensor systems to the computing system 120. In alternative implementations, the one or more motion sensor systems can be communicatively coupled to the computing system 120 via the one or more wireless networks 130. In such implementations, the one or more motion sensor systems can communicate motion data to the computing system 120 via the one or more wireless networks 130.

The computing system 120 can be configured to determine a motion signature for the person 102 based, at least in part, on the motion data indicative of motion of the one or more earpieces 110. Furthermore, in some implementations, the computing system 120 can be configured to determine the motion signature for the person 102 based on the motion data indicative of motion of the one or more earpieces 110 and motion data captured by one or more motion sensor systems (e.g., wrist watch) worn by the person 102. The motion signature can be indicative of a motion that is unique to the person 102. For instance, in some implementations, the motion signature can be indicative of a gait of the person 102. It should be understood that the motion signature can include any type of motion that is unique to the person 102.

In some implementations, the computing system 120 can include one or more machine-learned motion classifier models. In such implementations, the computing system 120 can be configured to provide the motion data indicative of the motion of the one or more earpieces as an input to the one or more machine-learned motion classifier models. The one or more learned motion classifier models can be configured to classify the motion data to determine the motion signature for the person 102. Furthermore, in such implementations, the motion signature for the person 102 can be provided as an output of the one or more machine-learned motion classifier models.

The computing system 120 can be configured to authenticate an identity of the person 102 wearing the one or more earpieces 110 based, at least in part, on the motion signature. For instance, in some implementations, the computing system 120 can be configured to provide the motion signature as an input to one or more machine-learned motion classifier models. The one or more machine-learned motion classifier models can be configured to classify the motion signature to determine an identity of the person 102 wearing the one or more earpieces 110. Furthermore, in such implementations, the identity of the person 102 can be provided as an output of the one or more machine-learned motion classifier models.

In alternative implementations, the computing system 120 can be configured to compare the motion signature for the person 102 to a plurality of motion signatures. It should be appreciated that each of the plurality of motion signatures can be associated with a different person. In this manner, the computing system 120 can determine whether the motion signature for the person 102 corresponds to the motion signature for one of the plurality of motion signatures. For example, the computing system 120 can determine the motion signature for the person 102 corresponds to a first motion signature of the plurality of motion signatures. Furthermore, since each of the plurality of motion signatures is associated with a different person, the computing system 120 can determine the identity of the person 102 wearing the one or more earpieces 110 corresponds to the identity of the person associated with the first motion signature of the plurality of motion signatures.

In some implementations, the computing system 120 can be configured to provide a notification indicative of whether the identity of the person 102 wearing the earpiece 110 has been authenticated. For instance, the notification can be displayed via one or more output devices 140 (e.g., display screen, speaker, etc.) of the person authentication system 100. It should be appreciated that the notification can include at least one of an audible or visual alert. In some implementations, the one or more output devices 140 can be positioned at the entrance to the restricted area. In this manner, personnel posted at the entrance to the restricted area can determine whether to permit the person 102 wearing the earpiece 110 to enter the restricted area based, at least in part, on the notification.

In some implementations, the computing system 120 can be communicatively coupled with one or more wearable devices 150 other than the one or more earpieces 110. The one or more wearable devices 150 can include one or more biometric sensors configured to obtain biometrics of the person 102. For instance, in some implementations, the one or more wearable devices 150 can include a heart rate monitor. It should be understood, however, that the one or more wearable devices 150 can include any device capable of being worn by the person 102 and having one or more biometric sensors.

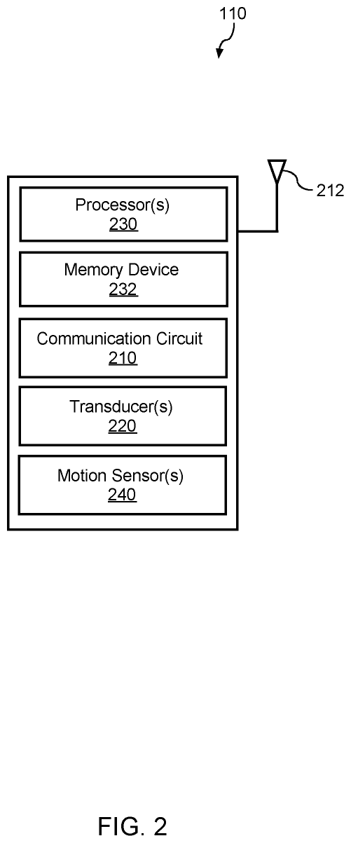

Referring now to FIG. 2, components of the one or more earpieces 110 are provided according to example embodiments of the present disclosure. As shown, the one or more earpieces 110 can include a communication circuit 210 and an antenna 212. In this manner the one or more earpieces 110 can transmit and receive data. In some implementations, the communication circuit 210 can include a near-field communication circuit. The antenna 212 can, in some implementations, include an antenna having a fixed radiation pattern.

In alternative implementations, the antenna 212 can include a modal antenna configurable in a plurality of antenna modes. Furthermore, each of the plurality of antenna modes can have a distinct radiation pattern, polarization, or both. In some implementations, the modal antenna can be configured in different antenna modes based, at least in part, on a link quality (e.g., channel quality indicator) between the modal antenna and a receiver (e.g., another earpiece, access point, base station).

For instance, the modal antenna can be configured in different antenna modes as the person 102 (FIG. 1) navigates an area to steer the radiation pattern towards the receiver (e.g., other earpieces, access points, base stations) in the area. In this manner, a link quality (e.g., channel quality indicator) between the modal antenna and the receiver (e.g., other earpieces, access points, base stations, etc.) can be improved.

The one or more earpieces 110 can further include one or more transducers 220. The one or more transducers 220 can be configured to convert an electrical signal to an audio signal. For instance, the electrical signal can be received via the antenna 212 and can be provided as an input to the one or more transducers 220. The one or more transducers 220 can convert the electrical signal to output the audio signal. In this manner, audible noise associated with the audio signal can be provided to a corresponding ear 104, 106 (FIG. 1) of the person 102 (FIG. 1).

The one or more earpieces 110 can include one or more processors 230 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, microcontroller, a microcomputer, a programmable logic controller (PLC), an application specific integrated circuit (ASIC), a Field Programmable Gate Array (FPGA), and other programmable circuits.

The one or more earpieces 110 can include a memory device 232. Examples of the memory device 232 can include computer-readable media including, but not limited to, non-transitory computer-readable media, such as RAM, ROM, hard drives, flash drives, or other suitable memory devices. The memory device 232 can store information accessible by the one or more processors 230 including the unique identifier 234 associated with the one or more earpieces 110. The one or more processors 230 can access the memory device 232 to obtain the unique identifier 234. For instance, in some implementations, the one or more processors 230 can be configured to generate a beacon signal that includes the unique identifier 234. Furthermore, the one or more processors 230 can be further configured to transmit the beacon signal via the antenna 212.

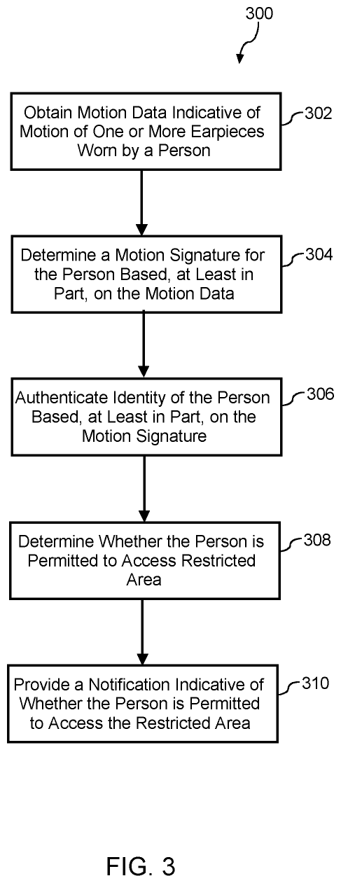

In some implementations, the one or more earpiece 110 can include one or more motion sensors 240 configured to obtain motion data indicative of motion of the one or more earpieces 110. For instance, in some implementations, the one or more motion sensors 240 can include an accelerometer. The accelerometer can be configured to obtain data indicative of acceleration of the earpiece 110 along one or more axes. Alternatively, or additionally, the one or more motion sensors 240 can include a gyroscope. The gyroscope can be configured to obtain data indicative of orientation of the earpiece 110. Additionally, the gyroscope can be configured to obtain data indicative of angular velocity of the one or more earpieces 110. Referring now to FIG. 3, a flow diagram of a method 300 of authenticating an identity of a person is provided according to example embodiments of the present disclosure. In general, the method 400 will be discussed herein with reference to the person authentication system 100 described above with reference to FIG. 1. In addition, although FIG. 3 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

At (302), the method 300 can include obtaining, by a computing system having one or more computing devices, motion data indicative of motion of one or more earpieces worn by a person. In some implementations, obtaining motion data indicative of motion of the one or more earpieces worn by the person can include obtaining, by the computing system, first motion data indicative of motion of a first earpiece worn in a first ear (e.g., right ear) of the person. Additionally, obtaining motion data indicative of motion of the one or more earpieces worn by the person can further include obtaining, by the computing system, second motion data indicative of motion of a second earpiece worn in a second ear (e.g., left ear) of the person.

At (304), the method 300 can include determining, by the computing system, a motion signature for the person based, at least in part, on the motion data obtained at (302). The motion signature can be unique to the person wearing the one or more earpieces. For instance, in some implementations, the motion signature can be indicative of a gait of the person. It should be appreciated, however, that the motion signature can be indicative of any suitable motion that is unique to the person 102.

At (306), the method 300 can include authenticating, by the computing system, the identity of the person wearing the one or more earpieces based, at least in part, on the motion signature determined at (304). For instance, in some implementations, authenticating the identity of person wearing the one or more earpieces can include determining a name of the person wearing the one or more earpieces based, at least in part, on the motion signature.

At (308), the method 300 can include determining, by the computing system, whether the person wearing the one or more earpiece is permitted to access a restricted area the person is attempting to enter. For instance, determining whether the person wearing the earpiece is permitted to access the restricted area can include, for instance, accessing, by the computing system, a database storing data that is indicative of persons permitted to access the restricted area. In some implementations, the data stored in the database can include a list of persons that are permitted to access the restricted area. It should be understood, however, that the data can be stored in the database in any suitable format.

At (310), the method 300 can include providing, by the computing system, a notification indicative of whether the person wearing the earpiece is permitted to access the restricted area. For instance, in some implementations, providing the notification can include providing, by the computing system, the notification for display on the one or more output devices located at an entrance to the restricted area. It should be understood that the notification can include at least one of an audible alert or a visual alert.

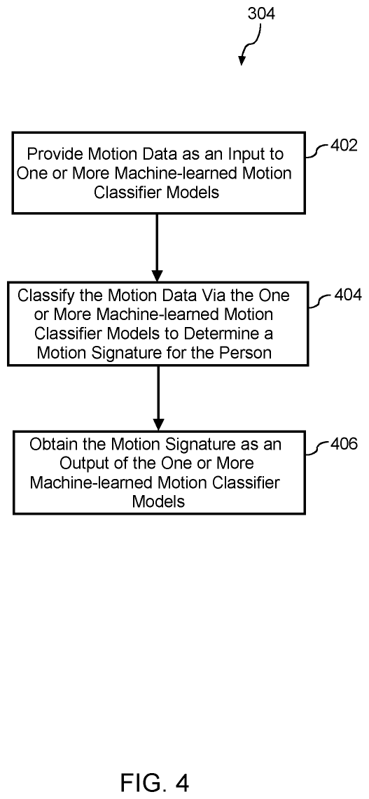

Referring now to FIG. 4, a flow diagram of a process for determining a motion signature for the person at (304) of the method 300 discussed above with reference to FIG. 3 is provided according to an example embodiment of the present disclosure. As shown, determining the motion signature for the person can include, at (402), providing the motion data as an input to one or more machine-learned motion classifier models. The process of determining the motion signature of the person can further include, at (404), classifying the motion data to determine the motion signature for the person. Still further, the process of determining the motion signature for the person can include, at (406), providing the motion signature as an output of the one or more machine-learned motion-classifier models.

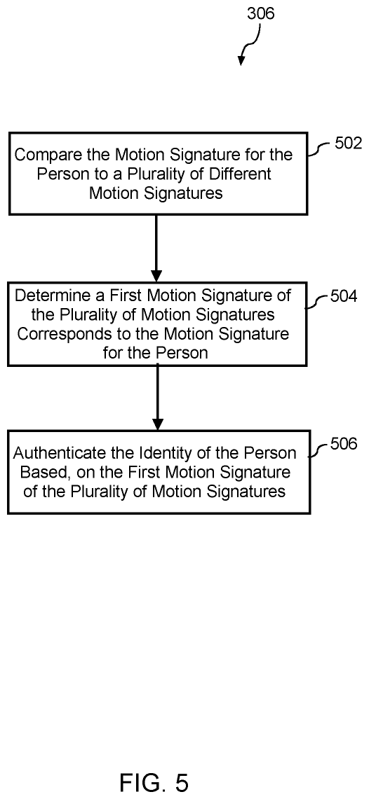

Referring now to FIG. 5, a flow diagram of a process for authenticating the identity of the person at (306) of the method 300 discussed above with reference to FIG. 3 is provided according to an example embodiment of the present disclosure. As shown, authenticating the identity of the person wearing the one or more earpieces can include, at (502), comparing the motion signature for the person to a plurality of different motion signatures. It should be understood that each of the plurality of motion signatures can be associated with a different person. At (504), the process for authenticating the identity of the person can include determining a first motion signature of the plurality of motion signatures corresponds to the motion signature for the person. At (506), the process for authenticating the identity of the person wearing the one or more earpieces can include authenticating the identity of the person wearing the one or more earpieces based, at least in part, on the first motion signature of the plurality of motion signatures.

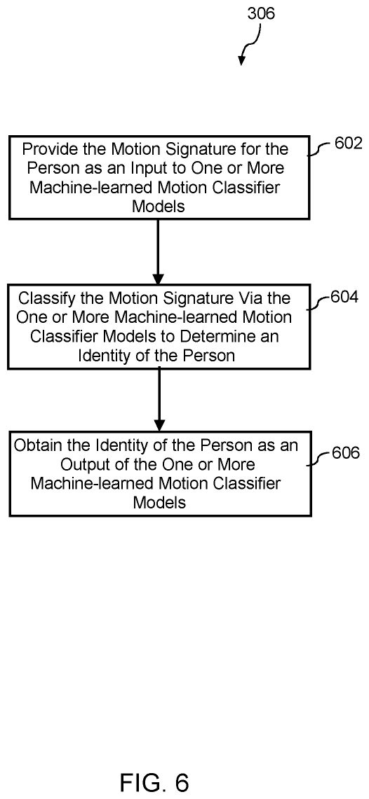

Referring now to FIG. 6, a flow diagram of a process for authenticating the identity of the person at (306) of the method 300 discussed above with reference to FIG. 3 is provided according to an example embodiment of the present disclosure. As shown, authenticating the identity of the person waring the one or more earpieces can include, at (602), providing the motion signature for the person as an input to one or more machine-learned motion classifier models. The process of authenticating the identity of the person wearing the one or more earpieces can further include, at (604), classifying the motion data to determine the motion signature for the person. Still further, the process of authenticating the identity of the person wearing the one or more earpieces can include, at (606), providing the motion signature as an output of the one or more machine-learned motion classifier models.

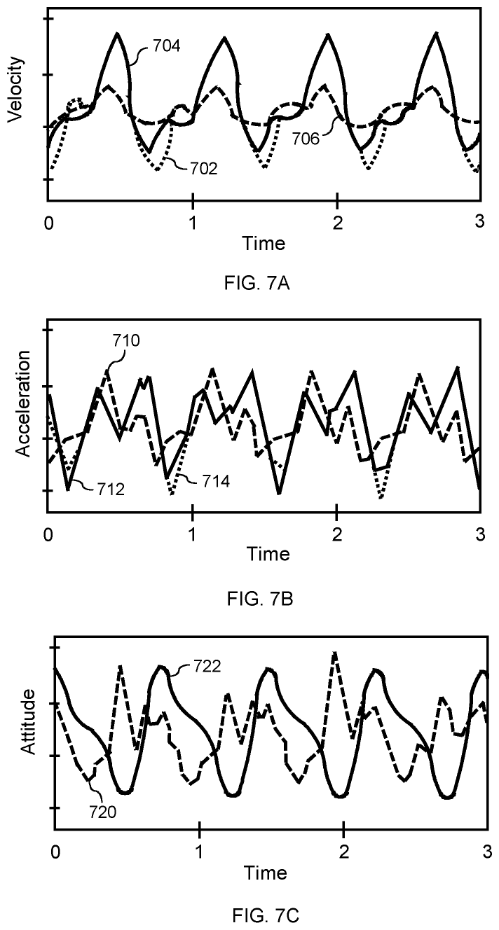

Referring now to FIGS. 7A-7C, various examples of motion data indicative of motion of an earpiece are provided according to example embodiments of the present disclosure. FIG. 7A depicts motion data indicative of velocity of the earpiece as a function of time. For instance, curve 702 depicts velocity of the earpiece along a first axis (e.g., roll axis). Curve 704 depicts velocity of the earpiece along a second axis (e.g., pitch axis). Curve 706 depicts velocity of the earpiece along a third axis (e.g., yaw axis).

FIG. 7B depicts motion data indicative of acceleration of the earpiece as a function of time. For instance, curve 712 depicts acceleration of the earpiece along the first axis (e.g., roll axis). Curve 712 depicts acceleration of the earpiece along the second axis (e.g., pitch axis). Curve 714 depicts acceleration of the earpiece along the third axis (e.g., yaw axis). FIG. 7C depicts motion data indicative of orientation of the earpiece relative to Earth's horizontal axis as a function of time. For instance, curve 720 depicts a roll attitude of the earpiece, where curve 722 depicts a pitch attitude of the earpiece.

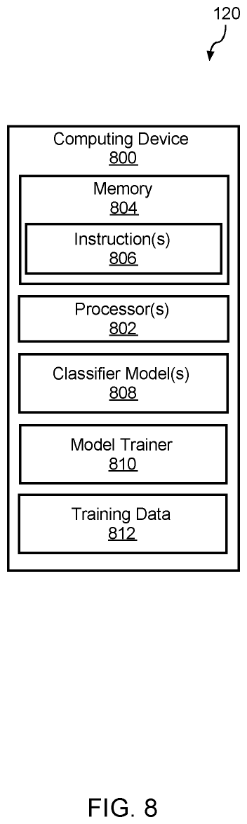

FIG. 8 illustrates suitable components of the computing system 120 according to example embodiments of the present disclosure. The computing system 120 can include one or more computing devices 800. The one or more computing devices 700 can include one or more processors 802 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, microcontroller, a microcomputer, a programmable logic controller (PLC), an application specific integrated circuit (ASIC), a Field Programmable Gate Array (FPGA), and other programmable circuits.

As shown, the computing system 120 can include a memory device 804. Examples of the memory device 804 can include computer-readable media including, but not limited to, non-transitory computer-readable media, such as RAM, ROM, hard drives, flash drives, or other suitable memory devices. The memory device 804 can store information accessible by the one or more processors 802 including computer-readable instructions 806 that can be executed by the one or more processors 802. The computer-readable instructions 806 can be any set of instructions that, when executed by the one or more processors 802, cause the one or more processors 802 to perform operations associated with authenticating the identity of the person wearing the earpiece. The computer-readable instructions 806 can be software written in any suitable programming language or can be implemented in hardware. In some implementations, the computing system 120 can include one or more motion classifier models 808. For example, the one or more motion classifier models 808 can include various machine-learned models, such as a random forest classifier; a logistic regression classifier; a support vector machine; one or more decision trees; a neural network; and or other types of machine-learned models, including both linear models and non-linear models. Example neural networks can include feed-forward neural networks, recurrent neural networks (e.g., long short-term memory recurrent neural networks), or other forms of neural networks.

In some implementations, the computing system 120 can train the one or more motion classifier models 808 through use of a model trainer 810. The model trainer 810 can train the one or more classifier models 708 using one or more training or learning algorithms. One example training technique is backwards propagation of errors (“backpropagation”). For example, backpropagation can include Levenberg-Marquardt backpropagation. In some implementations, the model trainer 810 can perform supervised training techniques using a set of labeled training data. In other implementations, the model trainer 810 can perform unsupervised training techniques using a set of unlabeled training data. The model trainer 710 can perform a number of generalization techniques to improve the generalization capability of the models being trained. Generalization techniques include weight decays, dropouts, or other techniques.

In particular, the model trainer 810 can train the one or more motion classifier models 808 based on a set of training data 812. The training data 812 can includes a number of training examples. Each training example can include example images of the ear (e.g., inner portion, outer portion) of different persons. In this manner, the one or more classifier models 708 can learn to classify the different images of the ear.

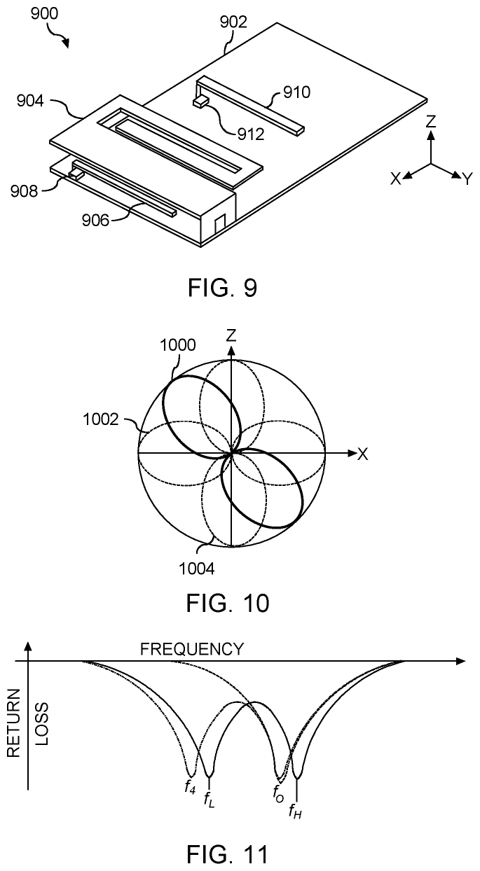

FIG. 9 illustrates an example embodiment of a modal antenna 900 according to the present disclosure. The modal antenna 900 can, for instance, be used in the earpiece 110 (FIG. 2). For instance, the antenna 212 (FIG. 2) of the earpiece 110 can include the modal antenna 900. The modal antenna can be configurable in a plurality of antenna modes. Each of the antenna modes can have a distinct radiation pattern, polarization, or both. The modal antenna 900 can be configured in different antenna modes based, at least in part, on a link quality (e.g., channel quality indicator) between the earpiece and another device (e.g., other earpiece, access point, base station) to steer the radiation pattern of the modal antenna 900 towards the device. In this manner, the antenna mode of the modal antenna 900 can be adjusted as needed to maintain the communication link between the earpiece and another device as the user navigates an area.

As shown, the driven element 904 of the modal antenna 900 can be disposed on an circuit board 902. An antenna volume may be defined between the circuit board 902 (e.g., and the ground plane) and the driven element 904. The modal antenna 900 can include a first parasitic element 906 positioned at least partially within the antenna volume. The modal antenna 900 can further include a first tuning element 908 coupled with the first parasitic element 906. The first tuning element 908 can be a passive or active component or series of components and can be configured to alter a reactance on the first parasitic element 906 either by way of a variable reactance or shorting to ground. It should be appreciated that altering the reactance of the first parasitic element 906 can result in a frequency shift of the modal antenna 900. It should also be appreciated that the first tuning element 908 can include at least one of a tunable capacitor, MEMS device, tunable inductor, switch, a tunable phase shifter, a field-effect transistor, or a diode.

In some implementations, the modal antenna 900 can include a second parasitic element 910 disposed adjacent the driven element 904 and outside of the antenna volume. The modal antenna 900 can further include a second tuning element 912. In some implementations, the second tuning element 912 can be a passive or active component or series of components and may be configured to alter a reactance on the second parasitic element 910 by way of a variable reactance or shorting to ground. It should be appreciated that altering the reactance of the second parasitic element 910 can result in a frequency shift of the modal antenna 900. It should also be appreciated that the second tuning element 912 can include at least one of a tunable capacitor, MEMS device, tunable inductor, switch, a tunable phase shifter, a field-effect transistor, or a diode.

In some implementations, operation of at least one of the first tuning element 908 and the second tuning element 912 can be controlled to adjust (e.g., shift) the antenna radiation pattern of the driven element 904. For example, a reactance of at least one of the first tuning element 908 and the second tuning element 912 can be controlled to adjust the antenna radiation pattern of the driven element 904.

Adjusting the antenna radiation pattern can be referred to as “beam steering”. However, in instances where the antenna radiation pattern includes a null, a similar operation, commonly referred to as “null steering”, can be performed to shift the null to an alternative position about the driven element 904 (e.g., to reduce interference). FIG. 10 depicts antenna radiation patterns associated with the modal antenna 900 of FIG. 9 according to example embodiments of the present disclosure. It should be appreciated that operation of at least one of the first parasitic element 906 and the second parasitic element 910 can be controlled to configure the modal antenna 900 in a plurality of modes. It should also be appreciated that the modal antenna 900 can have a distinct antenna radiation pattern or antenna polarization when configured in each of the plurality of modes.

In some implementations, the modal antenna 900 can have a first antenna radiation pattern 1000 when the modal antenna 900 is configured in a first mode of the plurality of modes. In addition, the modal antenna 900 can have a second antenna radiation pattern 1002 when the modal antenna 900 is configured in a second mode of the plurality of modes. Furthermore, the modal antenna 900 can have a third antenna radiation pattern 1004 when the modal antenna 900 is configured in a third mode of the plurality of modes. As shown, the first antenna radiation pattern 1000, the second antenna radiation pattern 1002, and the third antenna radiation pattern 1004 can be distinct from one another. In this manner, the modal antenna 900 can have a distinct radiation pattern when configured in each of the first mode, second mode, and third mode.

FIG. 11 depicts an example frequency plot of the modal antenna 900 of FIG. 9 according to example embodiments the present disclosure. It should be understood that an electrical characteristic (e.g., reactance) of at least one of the first parasitic element 906 and the second parasitic element 910 can be controlled. In this manner, the electrical characteristic of at least one of the first parasitic element 906 and the second parasitic element 910 can be adjusted to shift a frequency at which the modal antenna 900 is operating.

In some implementations, the modal antenna 900 can be tuned to a first frequency f₀ when the first parasitic element 906 and the second parasitic element 910 are deactivated (e.g., switched off). Alternatively, or additionally, the modal antenna 900 can be tuned to frequencies f_{L} and f_{H} when the second parasitic element 910 is shorted to ground. Furthermore, the modal antenna 900 can be tuned to frequency f₄ when both the first parasitic element 906 and the second parasitic element 910 are shorted to ground. Still further, the modal antenna 900 can be tuned to frequencies f₄ and f₀ when the first parasitic element 906 and the second parasitic element 910 are each shorted to ground. It should be understood that other configurations are within the scope of this disclosure. For example, more or fewer parasitic elements may be employed. The positioning of the parasitic elements may be altered to achieve additional modes that may exhibit different frequencies and/or combinations of frequencies.

FIGS. 9-11 depict one example modal antenna having a plurality of modes for purposes of illustration and discussion. Those of ordinary skill in the art, using the disclosures provided herein, will understand that other modal antennas and/or antenna configurations can be used without deviating from the scope of the present disclosure. As used herein a “modal antenna” refers to an antenna capable of operating in a plurality of modes where each mode is associated with a distinct radiation pattern.

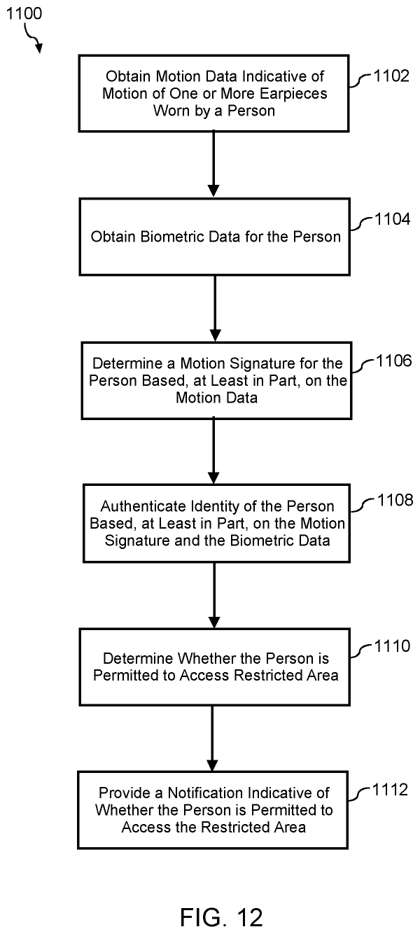

Referring now to FIG. 12, a flow diagram of a method 1100 of authenticating an identity of a person is provided according to example embodiments of the present disclosure. In general, the method 1100 will be discussed herein with reference to the person authentication system 100 described above with reference to FIG. 1. In addition, although FIG. 12 depicts steps performed in a particular order for purposes of illustration and discussion, the method 1100 described herein is not limited to any particular order or arrangement. One skilled in the art, using the disclosure provided herein, will appreciate that various steps of the method 1110 disclosed herein can be omitted, rearranged, combined, and/or adapted in various ways without deviating from the scope of the present disclosure.

At (1102), the method 1100 can include obtaining, by a computing system having one or more computing devices, motion data indicative of motion of one or more earpieces worn by a person. In some implementations, obtaining motion data indicative of motion of the one or more earpieces worn by the person can include obtaining, by the computing system, first motion data indicative of motion of a first earpiece worn in a first ear (e.g., right ear) of the person. Additionally, obtaining motion data indicative of motion of the one or more earpieces worn by the person can further include obtaining, by the computing system, second motion data indicative of motion of a second earpiece worn in a second ear (e.g., left ear) of the person.

At (1104), the method 1100 can include obtaining, by the computing system, biometric data (e.g., heart rate) for the person. For instance, in some implementations, the one or more earpieces can include one or more biometric sensors (e.g., heart rate sensor) configured to obtain biometrics (e.g., heart rate) of the person. Alternatively, or additionally, the one or more earpieces can be communicatively coupled with one or more wearable devices (e.g., heart rate monitor) that include one or more biometric sensors configured to obtain biometrics of the person.

At (1106), the method 1100 can include determining, by the computing system, a motion signature of the person based, at least in part, on the motion data obtained at (1102). It should be understood that the motion signature of the person can be determined using method discussed above with reference to FIG. 4.

At (1108), the method 1100 can include authenticating, by the computing system, the identity of the person wearing the one or more pieces based, at least in part, on the motion signature determined at (1106) and the biometric data obtained at (1104). It should be understood that the methods for authenticating the identity of the person based on the motion signature as discussed above with reference to FIGS. 5 and 6 can be implemented. Additionally, the identity of the person wearing the one or more earpieces can be further authenticated based on the biometric data obtained at (1104). For instance, in instances in which the motion signature of the person wearing the one or more earpieces corresponds to a recognized motion signature, the biometric data can be used to further authenticate the identity of the person. If, for example, the biometric data (e.g., heart rate) indicates the person is nervous (e.g., heart rate is above a threshold value), the computing system can be configured to require additional information in order to authenticate the identity of the person. In this manner, the computing system avoid authenticating the identity of the person wearing the one or more earpieces in instances in which the person's motion signature matches a recognized motion signature but biometric data indicates that the person may not be the person corresponding to the recognized motion signature.

At (1110), the method 1100 can include determining, by the computing system, whether the person wearing the one or more earpiece is permitted to access a restricted area the person is attempting to enter. For instance, determining whether the person wearing the earpiece is permitted to access the restricted area can include, for instance, accessing, by the computing system, a database storing data that is indicative of persons permitted to access the restricted area. In some implementations, the data stored in the database can include a list of persons that are permitted to access the restricted area. It should be understood, however, that the data can be stored in the database in any suitable format.

At (1112), the method 1100 can include providing, by the computing system, a notification indicative of whether the person wearing the earpiece is permitted to access the restricted area. For instance, in some implementations, providing the notification can include providing, by the computing system, the notification for display on the one or more output devices located at an entrance to the restricted area. It should be understood that the notification can include at least one of an audible alert or a visual alert.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of Zo ordinary skill in the art.

What is claimed is:

1. A method of authenticating an identity of a person wearing one or more earpieces, the method comprising:
obtaining, by a computing system comprising one or more computing devices, motion data indicative of motion of one or more earpieces worn by the person;
determining, by the computing system, a motion signature for the person based, at least in part, on the motion data, the motion signature being unique to the person; and
authenticating, by the computing system, the identity of the person based, at least in part, on the motion signature.

2. The method of claim 1, wherein obtaining motion data indicative of motion of one or more earpieces comprises:
obtaining, by the computing system, first motion data indicative of motion of a first earpiece worn in a first ear of the person; and
obtaining, by the computing system, second motion data indicative of motion of a second earpiece worn in a second ear of the person.

3. The method of claim 2, wherein:
obtaining first motion data indicative of motion of the first earpiece comprises obtaining, by the computing system, one or more signals from one or more motion sensors of the first earpiece; and
obtaining second data from the second earpiece comprises obtaining, by the computing system, one or more signals from one or more motion sensors of the second earpiece.

4. The method of claim 3, wherein the one or more motion sensors of at least one of the first earpiece and the second earpiece comprise at least one of an accelerometer and a gyroscope.

5. The method of claim 1, wherein determining the motion signature for the person based, at least in part, on the motion data comprises:
providing, by the computing system, the motion data as an input to one or more machine-learned motion classifier models;
classifying, by the computing system, the motion data via the one or more machine-learned motion classifier models to determine the motion signature for the person; and
obtaining, by the computing system, the motion signature for the person as an output of the one or more machine-learned motion classifier models.

6. The method of claim 1, wherein authenticating the identity of the person comprises:
providing, by the computing system, the motion signature as an input to one or more machine-learned motion classifier models;
classifying, by the computing system, the motion signature via the one or more machine-learned motion classifier models to determine the identity of the person wearing the one or more earpieces; and
obtaining, by the computing system, the identity of the person as an output of the one or more machine-learned motion classifier models.

7. The method of claim 1, wherein authenticating the identity of the person comprises:
comparing, by the computing system, the motion signature for the person to a plurality of motion signatures, each of the plurality of motion signatures associated with a different person;
determining, by the computing system, a first motion signature of the plurality of motion signatures corresponds to the motion signature for the person; and
determining, by the computing system, the identity of the person wearing the one or more earpieces based, at least in part, on the first motion signature.

8. The method of claim 1, further comprising:
responsive to authenticating the identity of the person, determining, by the computing system, whether the person is permitted to access an area based, at least in part, on the identity of the person.

9. The method of claim 1, further comprising:
obtaining, by the computing system, biometric data for the person; and
wherein authenticating the identity of the person comprises authenticating, by the computing system, the identity of the person based on the motion signature and the biometric data.

10. A person authentication system comprising:
one or more earpieces, the one or more earpieces comprising one or more motion sensors; and
a computing system communicatively coupled to the one or more earpieces, the computing system comprising one or more computing devices, the computing system configured to perform operations, the operations comprising:
obtaining motion data indicative of motion of the one or more earpieces when the one or more earpieces are being worn by the person;
determining a motion signature for the person based, at least in part, on the motion data, the motion signature being unique to the person; and
authenticating an identity of the person based, at least in part, on the motion signature.

11. The person authentication system of claim 10, wherein the one or more earpieces comprise a first earpiece and a second earpiece, the first earpiece configured to be worn in a first ear of the person, the second earpiece configured to be worn in a second ear of the person.

12. The person authentication system of claim 10, wherein the one or more motion sensors comprise at least one of an accelerometer and a gyroscope.

13. The person authentication system of claim 10, wherein the one or more earpieces comprise a modal antenna configurable in a plurality of antenna modes, each of the plurality of antenna modes having a distinct radiation pattern.

14. The person authentication system of claim 11, wherein obtaining motion data indicative of motion of the one or more earpieces comprises:
obtaining first motion data indicative of motion of a first earpiece worn in a first ear of the person; and
obtaining second motion data indicative of motion of a second earpiece worn in a second ear of the person.

15. The person authentication system of claim 14, wherein
obtaining first motion data indicative of motion of the first earpiece comprises obtaining, by the computing system, one or more signals from one or more motion sensors of the first earpiece; and
obtaining second data from the second earpiece comprises obtaining, by the computing system, one or more signals from one or more motion sensors of the second earpiece.

16. The person authentication system of claim 10, wherein the operation of determining the motion signature for the person based, at least in part, on the motion data comprises:
Providing the motion data as an input to one or more machine-learned motion classifier models;
classifying the motion data via the one or more machine-learned motion classifier models to determine the motion signature for the person; and
obtaining the motion signature for the person as an output of the one or more machine-learned motion classifier models.

17. The person authentication system of claim 10, wherein the operation of authenticating the identity of the person comprises:
providing the motion signature as an input to one or more machine-learned motion classifier models;
classifying the motion signature via the one or more machine-learned motion classifier models to determine the identity of the person wearing the one or more earpieces; and
obtaining the identity of the person as an output of the one or more machine-learned motion classifier models.

18. The person authentication system of claim 10, wherein the computing system is communicatively coupled to the one or more earpieces via a wireless network.

19. The person authentication system of claim 10, wherein the motion signature is indicative of a gait of the person.

20. The person authentication system of claim 10, wherein the one or more earpieces are communicatively coupled to one or more motion sensor systems worn by the person.
